(19) United States
(12) Patent Application Publication
(10) Pub. No.: US 2012/0166462 A1
(43) Pub. Date: Jun. 28, 2012

(54) AUTOMATED IMAGE DATA PROCESSING AND VISUALIZATION

(75) Inventors: Sayan D. Pathak, Kirkland, WA (US); Antonio Criminisi, Hardwick (GB); Steven J. White, Seattle, WA (US); Liqun Fu, Mercer Island, WA (US); Khan M. Siddiqui, Highland, MD (US); Toby Sharp, Cambridge (GB); Ender Konukoglu, Cambridge (GB); Bryan Dove, Seattle, WA (US); Michael T. Gillam, Washington, DC (US)

(73) Assignee: Microsoft Corporation, Redmond, WA (US)

(21) Appl. No.: 12/979,362

(22) Filed: Dec. 28, 2010

(51) Int. Cl. G06F 17/30; G06F 3/048

(52) U.S. Cl. 707/758; 715/804; 715/764; 715/780; 707/E17.014; 707/E17.019

(57) ABSTRACT

The present discussion relates to automated image data processing and visualization. One example can facilitate generating a graphical user-interface (GUI) from image data that includes multiple semantically-labeled user-selectable anatomical structures. This example can receive a user selection of an individual semantically-labeled user-selectable anatomical structure. The example can locate a sub-set of the image data associated with the individual semantically-labeled user-selectable anatomical structure and can cause presentation of the sub-set of the image data on a subsequent GUI.

### BACKGROUND

New medical technologies are continually being developed. These technologies can contribute to improved patient outcomes. However, these technologies can produce vast amounts of patient data. Sorting through this patient data can be overwhelming to clinicians. Further, the sheer volume of the data tends to cause the data to be under-utilized. Accordingly, patient care lags behind the potential offered by these technologies. This issue is especially prevalent with imaging technologies, such as x-rays, ultrasound, CT scans, and MRIs, among others. A single patient may have gigabytes of imaging data for a clinician to sort through. The data becomes even more overwhelming given the number of patients handled by the average clinician.

### SUMMARY

The present discussion relates to automated image data processing and visualization. One example can facilitate generating a graphical user-interface (GUI) from image data that includes multiple semantically-labeled user-selectable anatomical structures, such as organs. This example can receive a user selection of an individual semantically-labeled user-selectable anatomical structure. The example can locate a sub-set of the image data associated with the individual semantically-labeled user-selectable anatomical structure and can cause presentation of the sub-set of the image data on a subsequent GUI.

Another example can receive a request for image data associated with a semantic label. The image data can be from a set of relatively recently obtained images of a patient. This example can retrieve other relatively older image data belonging to the patient and associated with a similar semantic label. The example can search for other non-image patient data that is germane to the semantic label.

The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIGS. 1-4 show examples of GUIs in which the present automated image data processing and visualization concepts can be employed in accordance with some implementations.

FIG. 5 shows an example of an automated image processing and visualization system in accordance with some implementations of the present concepts.

FIGS. 6-8 illustrate examples of flowcharts of automated image processing and visualization methods in accordance with some implementations of the present concepts.

### DETAILED DESCRIPTION

### Overview

This patent relates to automated semantic labeling of anatomical structures in patient images. More specifically this patent leverages automated semantic labeling techniques to provide meaningful patient image data to a user, such as a clinician.

Traditionally, image data has been very opaque to automated processing. Stated another way, image data has not been semantically interpretable by computers. Accordingly, end users, such as clinicians had to manually sort through and analyze the image data. The present implementations can automatically process the image data and apply semantic labels or tags to anatomical structures in the image data. The semantically labeled data can be accessed to present meaningful data to the clinician in a user friendly manner. Further, the semantically labeled data can now be associated with other patient data for the clinician. The semantically labeled image data can alternatively or additionally enable the computer to process and interpret the semantically labeled image data to produce clinically valuable results. For instance, the semantically labeled image data can be utilized in a quality control scenario.

These concepts are described in more detail below by way of several use case scenario examples, followed by discussion of a system example that can accomplish the use case scenario examples. Finally, several examples of methods that can be employed to accomplish the present concepts are discussed.

### USE CASE EXAMPLES

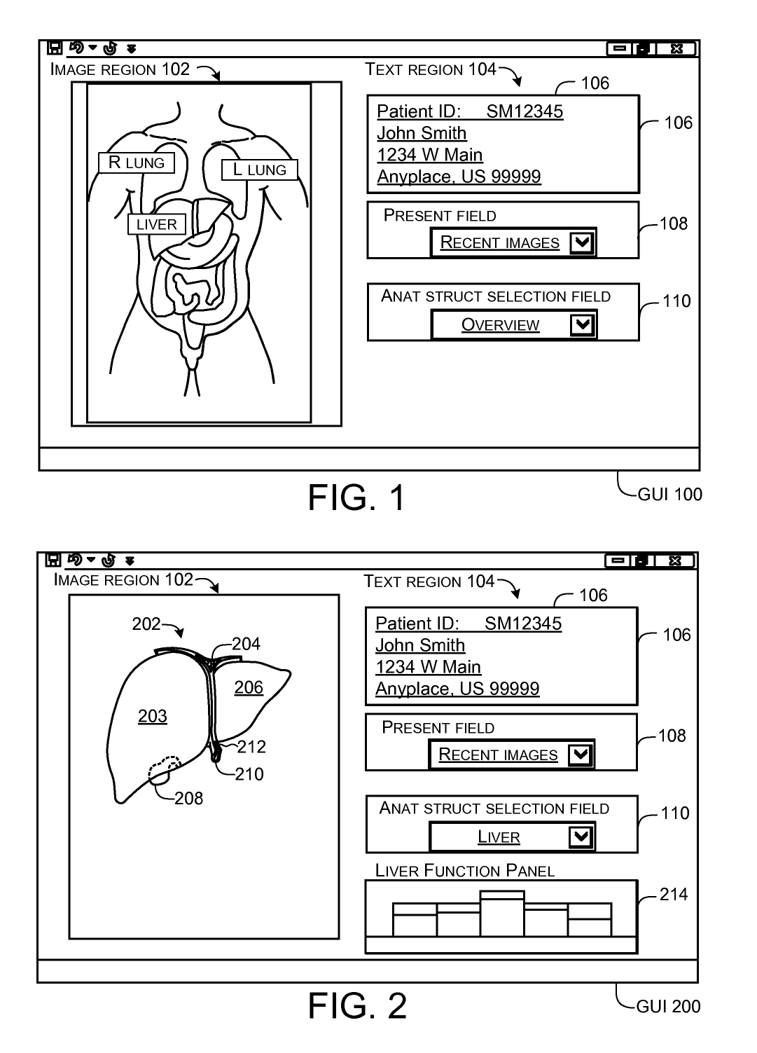

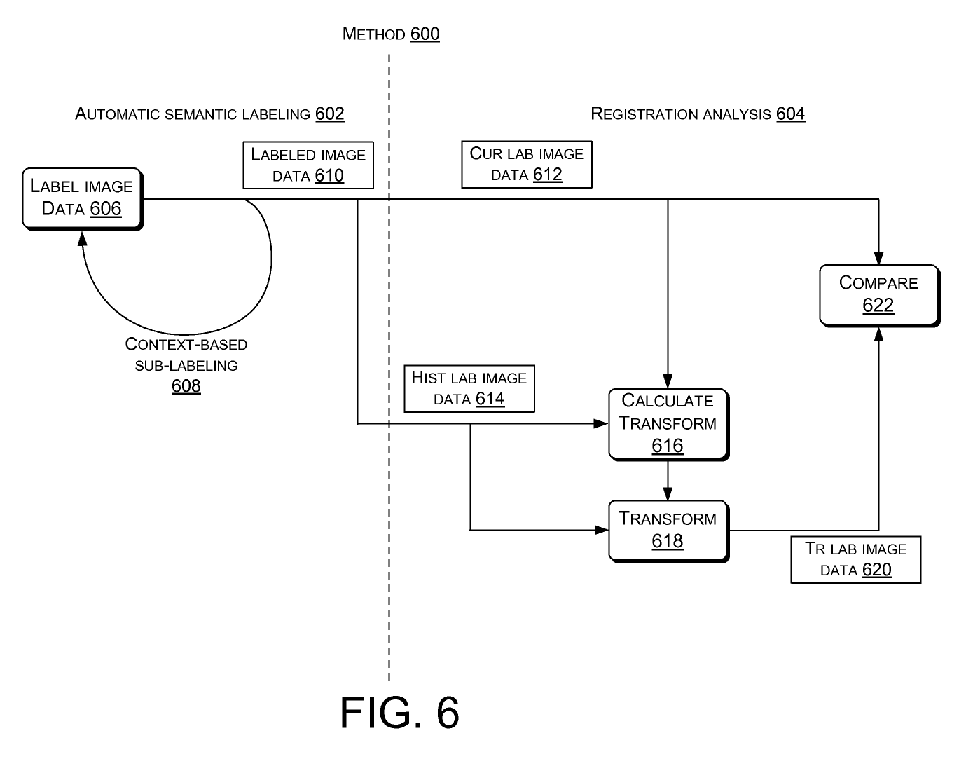

FIGS. 1-4 collectively illustrate several use case examples. For purposes of explanation assume that a patient has recently presented for care and that the patient's torso was imaged, such as via a CT scanner to obtain image data. Further, assume that semantic labeling was automatically performed on this recent image data to label anatomical structures contained in the image data. Semantic labeling techniques are described in more detail below relative to FIG. 6. Finally, assume that a clinician wants to view the recent image data. Accordingly, the clinician entered the patient's patient ID of SM12345 and requested recent images.

FIG. 1 includes a graphical user-interface (GUI) 100 generated responsive to the clinician's initial entries. In this case, GUI 100 includes an image region 102 and a text region 104. The image region is populated with a general view of the image region (e.g., thorax). This general view can be actual image data or an artistic drawing of a thorax. In either case, anatomical structures of the thorax can be labeled with the semantic labels generated during the above mentioned semantic labeling process. For instance, the “liver”, the “left lung” and the “right lung” are each labeled. (For sake of brevity, this example is simplified in the number of potentially labeled anatomical structures).

The text region 104 includes the patient ID field at 106, a present field at 108 that is populated with “recent images” and an anatomical structure selection field (or command window) 110 that is set at “overview”.

If the clinician wants to view the image data for the liver, the clinician can simply click on the liver semantic label (or the anatomical structure) in the image region 102. Alternatively, the clinician can enter ‘liver’ in the anatomical structure selection field 110. For instance, the clinician can type in the word ‘liver’ or select the word ‘liver’ from a drop-down menu or other listing of the semantically labeled anatomical structures. In either case, a single user action (e.g., a click or a word entry) can cause the clinician's desired anatomical structure to be displayed as evidenced in FIG. 2.

FIG. 2 shows a subsequent GUI 200 generated responsive to the clinician's actions. GUI 200 presents a relatively more detailed coronal or front view of the patient's liver as indicated at 202. Stated another way, the presentation can represent a sub-set of the recent patient image data that is associated with the “liver” semantic label. Further, in preparation for generating GUI 200 this sub-set of image data may be further processed to increase the value of the presented image to the clinician. For instance, the sub-set of the recent image data associated with the liver semantic label may be further processed to identify portions of the liver, liver structures, and/or other proximate anatomical structures. For example, in this case the right lobe 203, coronary ligament 204, left lobe 206, gallbladder 208, ligamentum teres 210 and falciform ligament 212 are labeled. (Note that the semantic labels are not included with the numerical designators for the features in FIG. 2 because of space constraints in the drawing page. In at least some implementations, the semantic labels could be evidenced on the image.) It may be difficult or impossible to correctly label some or all of these features 203-212 (e.g., sub-structures and/or smaller organs) from the patient's overall thorax image. However, when analyzed in the context of the sub-set of the image data associated with the liver label, identifying these elements becomes more probable with an additional pass of this subset of the image data through the semantic labeling algorithms. Stated another way, the fact that the sub-set of image data is associated with the liver can be used as contextual information that can enable identification of these further elements that would otherwise be unlikely.

The further processing of the sub-set of the recent image data for presentation may also relate to automated display settings. For example, various presentation or rendering parameters can be automatically selected to enhance the value of the presented image. For instance, the processing may automatically determine color parameters, contrast parameters, and/or transparency/opaqueness parameters etc., for the presentation that can enhance the usefulness of the presented sub-set of image data to the clinician. Automatic adjustment of these parameters can serve to contrast or distinguish the semantically labeled organ from the surrounding tissues.

Stated another way, knowing the individual anatomical structures in the anatomy before the presentation can allow some implementations to predetermine the set of rendering parameters that may be advantageous (and potentially the best) to enable the viewing of that anatomical structure. Traditionally, a physician, after navigating to a particular region in the body and manually labeling anatomical structures in the image data, ends up spending time choosing the appropriate window/level parameters. When visualizing anatomical structures rendered with different pseudo colors the physician needs to choose appropriate transfer functions, a.k.a. color-opacity map. However, in the present implementations since the context of the anatomical structure can be known a priori, settings can be automatically selected for these parameters thus introducing a huge improvement in clinical workflow efficiencies.

Another facet of the present implementation can be automatically obtaining and presenting relevant non-image data with the image data. For instance, in this case results of the patient's liver function panel are presented at 214 with the image of the liver on GUI 200. Of course, this is just one example and other non-image data can include other types of lab data, patient historical records, relevant medication and/or treatment information for the organs selected.

Viewed another way, the present implementations can recognize the clinical context of the selected anatomical structure and intelligently suggest appropriate clinical elements to present along with the current data. Examples could be known normal ranges of lab results, current average values for similar patients (identified by cohorts) shown as a comparison line, and marking identifiers for critical limits that if exceeded could cause immediate harm to patients, among others. In some cases, data associated with the visualization and/or customizations desired by an individual clinician can be stored in a library for future use. The library can decrease lag time associated with re-creation of the data.

Viewed another way, some of these solutions can leverage the current image data displayed on the screen to the user as well as known metadata about that image data to automatically suggest a context-appropriate visualization for this data. These visualizations could include standard 2-D graphs, timelines, evidence-based comparisons, specialized clinical visualizations (e.g. CBC Schematics), and/or geographical heat maps, among others.

Once this visualization is suggested based on the known metadata and the data the user has selected on the screen, the user can then customize the visualization. Some initial customizations may be to add and/or remove trend lines, other data elements, and change the visualization type, among others.

After the user customizes their visualization, this can automatically become their default visualization for this data context until they change it or reset the default. All visualizations can also be available to be shared to the local “visualization library” such that other users are able to access these visualizations when they enter the same data context. Stated another way, the image labels can become one of the primary selection indices (like patient ID and study modality) for deciding how data is presented clinically.

While illustrated at the organ level, this feature can also be applied to sub-structures, and/or other proximate anatomical structures. For instance, in relation to FIG. 2, if the clinician clicks on the gallbladder 208 relevant test results to the gall bladder, such as lipid levels could be automatically retrieved and displayed.

The present implementations can also offer registration. Registration can be thought of as taking images from the patient at different imaging sessions (e.g., at different times) and aligning 2D or 3D versions from the different imaging sessions to enhance the comparative value. Registration can be used with multiple patients to allow more meaningful comparison and/or to create an image that represents an average from a selected group of patients. Both rigid and non-rigid deformations can be facilitated by knowing a number of organ labels and locations and matching those locations up across the scans.

In summary, some of the present implementations can serve to link patient data. For instance, recent image data associated with the liver via semantic labeling can be associated with older labeled image data and/or other non-image patient data that may be relevant to liver function. This linking can facilitate bundling the liver related data so that a single selection by the clinician can result in the presentation of the liver data, both image and non-image.

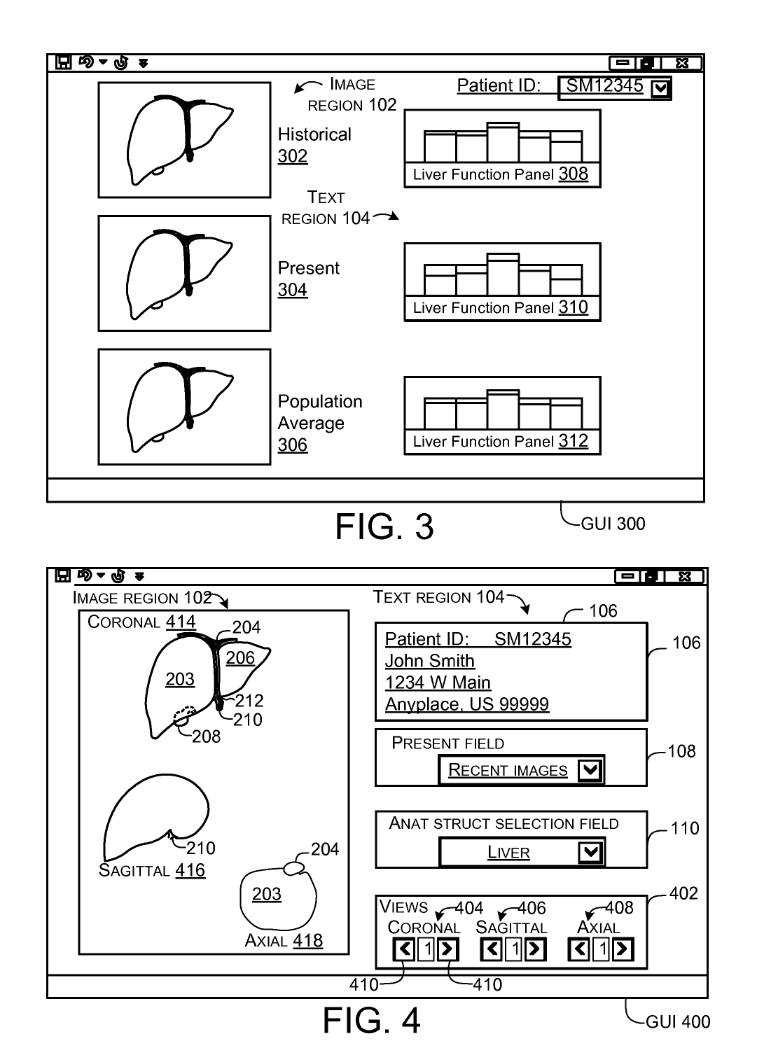

FIG. 3 shows a GUI 300 that illustrates registration concepts. GUI 300 includes three corresponding coronal views 302, 304, and 306 in image region 102. View 302 is a historical view from the patient. The historical view can be from a single previous patient imaging session or a cumulative view from multiple previous imaging sessions of the patient. View 304 is from the recent patient scanning session. View 306 is an average view from patients that have had the same type of scan. Registration can entail aligning, rotating, and/or scaling, etc. one set of images to allow more meaningful comparison to another set of images. In this implementation, each view 302-306 is accompanied by corresponding non-image data in the form of liver function panels 308, 310, and 312 in text region 104. This non-image data is discussed in more detail below.

In FIG. 3, the registration process identified the corresponding historical 302 and population average 306 views that match the recent view 304. Further, the registration process scaled the historical and population average views to match the size of the recent view and aligned the left edge of the three views to allow more meaningful comparison. In some cases, registration can transform (3D) image data from one imaging session (set of images) so that the resulting (2D) re-renderings more closely match another set of images from a different imaging session. Thus registration can allow more accurate tracking of disease progression. For instance, this technique can be valuable relative to multiple sclerosis where precisely registered images can be critical for comparing the change in size and status of the lesions over time.

Registration can be accomplished by matching image data from the recent session to the image data from the historical session(s) using matching semantic labels. For instance, a sub-set of the recent image data associated with the liver semantic tag can be compared to a sub-set of the historical image data associated with the liver semantic tag. This comparison can be used to calculate a linear transformation to align the sub-sets or to seed a more fine-grain non-linear warping of the one of the sub-sets to allow for matched projective views (e.g. MPR). This aspect is discussed in more detail below relative to FIG. 6.

Liver function panel 312 can also represent an example of how some of the present implementations can leverage non-image data (e.g., metadata) in a meaningful way for the clinician. In this example, the liver function panel 312 shows the population average to the clinician and allows meaningful comparison to the patient's liver function panel 310. In other scenarios, these implementations can leverage other types of metadata generated across a patient population and illustrate that patient population metadata in other meaningful ways. For instance, the metadata could be represented as a geographical heat map coded by diagnosis. In another example, the leveraged metadata can be presented in a visualization that plots a relationship between two or more parameters. In one such example, the visualization could plot a relationship between age and re-admission risk spread across cause of re-admission. The skilled artisan should recognize other applications for leveraging image data and/or non-image data in a manner that is clinically meaningful.

FIG. 4 shows another GUI 400. This GUI provides the user the opportunity to select views at 402. In this example, the user is allowed to select from coronal, sagittal, and axial views as indicated at 404, 406, and 408 respectively. Of course, other implementations can allow the user to select alternative or additional views. Further, the user can select specific images (e.g., slices) relative to a given view using the forward and back buttons designated at 410 and 412 respectively, relative to the coronal view 404.

Stated another way, once the semantic labeling is accomplished, such labeled data can be used to rapidly and reliably navigate in an image viewer to the sub-volumes so labeled. For instance, the user could click on a label (e.g. ‘Liver’) and immediately go to the first slice of a 3D volume set (axial view) or preset all three view projections (axial, sagittal, coronal) to be aligned with the edge or center of the described volume or, in the case of 3D ray-trace viewers, only render the tagged sub-volume thereby clearly localizing the organ of interest.

Note also, that in this implementation label elements in one image can be automatically populated to other images. This may be thought of as guided labeling. In this case there are three views illustrated: coronal at 414, sagittal at 416, and axial at 418. Assume for purposes of example that only the coronal liver view was originally labeled by the semantic labeling algorithms. The present implementations can automatically identify corresponding elements in the other views and label them for presentation. For instance, note that in the sagittal view 416 the ligamentum teres 210 is labeled and in the axial view 418 the right lobe 203 and the coronary ligament 204 are labeled utilizing the labels from the coronal view.

In another example, a patient may have a CT scan followed by several chest X-Rays. Using a combination of semantic labeling and registration, some implementations can map semantic labels from the CT image to the X-ray image in a fully automated manner.

Guided labeling can be utilized in other scenarios as well. For instance when labeling vertebral bodies in a spine, the semantic labeling algorithms can determine the relative positioning of the individual vertebra in the spine. Once a single vertebra is semantically labeled, either manually or automatically, the semantic labeling of the remainder of the vertebral bodies can be done automatically by leveraging the first one.

In another example, when semantic labeling is performed on the rib cage, some implementations can automatically point out which rib in this case is diseased (broken).

The present techniques also enable automated segmentation and/or annotated measurements of patient image data. For instance, the semantic labeling technology identifies bounding boxes behind the scenes. The present implementations can then use the bounding boxes as a sub-region of interest and get a fully automated segmentation of image regions which enables the subsequent automated anatomical measurements. Furthermore, these calculations offer additional enhancements to patient care. For instance, in radiation therapy setting, the calculation can be these techniques can be used to automatically determine an amount of radiation received per anatomical structure, such as per organ.

Further, quality control of patient care often relies upon review by the clinician. However, the present techniques offer meaningful comparison to be automatically performed between the semantically labeled recent images and historical images from the patient and/or other patients. Anomalies or differences are much more readily detected utilizing this automated process. These occurrences can be further evaluated automatically utilizing various algorithms and/or can be brought to the attention of the clinician.

For example, the semantically labeled image data can be analyzed to decide if the correct organs were scanned and the clinicians can be alerted when incorrect organs where scanned. In one such example, assume that a full torso scan was ordered. The present implementations can semantically label the anatomical structures in the obtained image data. These implementations can analyze the semantically labeled structures as a quality control parameter. For instance, continuing with the above example, assume that the semantically labeled structures include all of the ribs, but no clavicle. The technique may determine that a full torso view should include the clavicle. The technique may issue a quality control report indicating the possibility that the scan did not capture the full torso (e.g., stopped below the clavicle). In another example, assume that a CT scan is ordered with contrast. The technique may determine that the image data is inconsistent with a contrast scan. The technique can issue a quality control report that the contrast may have been performed improperly.

### SYSTEM EXAMPLE

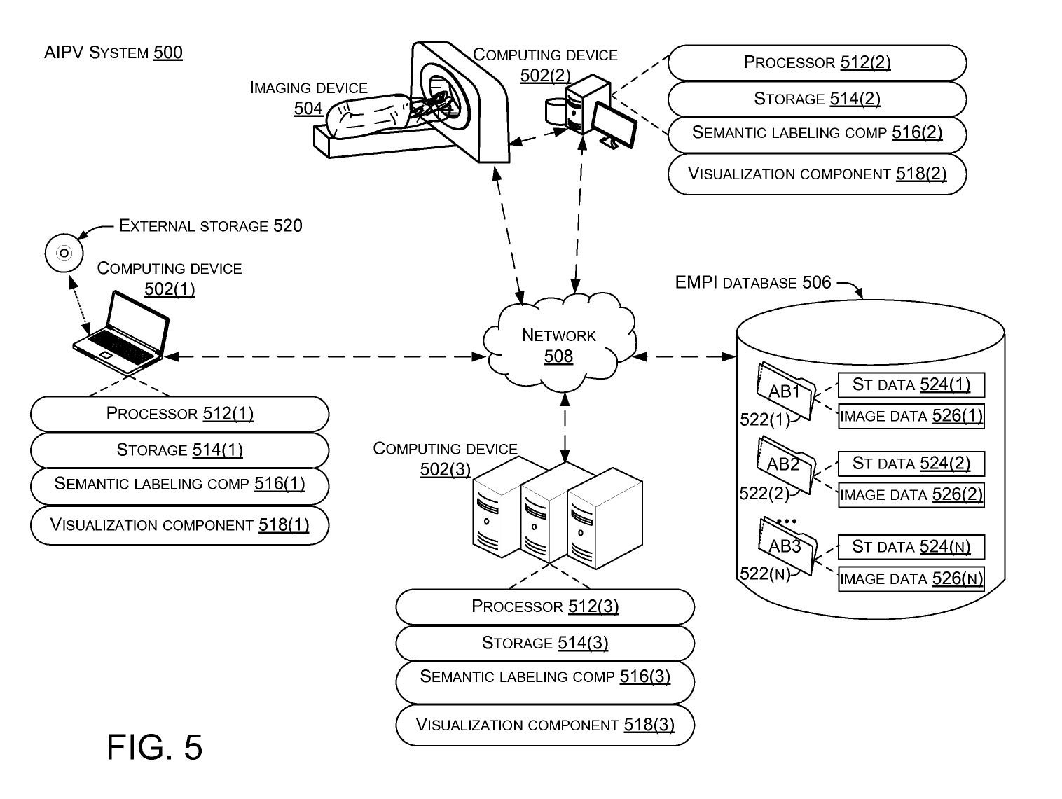

FIG. 5 shows an example of an automated image processing and visualization system (AIPV system) 500. Example AIPV system 500 can include one or more computing device(s) 502. For purposes of explanation, AIPV system 500 includes three computing devices 502(1), 502(2), and 502(3). AIPV system 500 also include an imaging device 504 and an electronic master patient index (EMPI) database 506. The various computing devices 502(1)-502(3), the imaging device 504, and the EMPI database 506 can communicate over one or more networks 508, such as, but not limited to, the Internet.

The term “computer” or “computing device” as used herein can mean any type of device that has some amount of processing capability. Examples of computing devices can include traditional computing devices, such as personal computers, cell phones, smart phones, personal digital assistants, or any of a myriad of ever-evolving or yet to be developed types of computing devices. Further, the AIPV system 500 can be manifest on a single computing device or distributed over multiple computing devices.

In this case, any of computing devices 502(1)-502(3) can include a processor 512, storage 514, a semantic labeling component 516, and a visualization component 518. (A suffix ‘(1)’ is utilized to indicate an occurrence of one of these elements on computing device 502(1), a suffix ‘(2)’ is utilized to indicate an occurrence of these elements on computing device 502(2), and a suffix ‘(3)’ is utilized to indicate an occurrence of these elements on computing device 502(3). Generic references to these elements do not include a suffix).

Processor 512 can execute data in the form of computer-readable instructions to provide a functionality. Data, such as computer-readable instructions, can be stored on storage 514. The storage can include any one or more of volatile or non-volatile memory, hard drives, and/or optical storage devices (e.g., CDs, DVDs etc.), among others. The computing devices 502(1)-502(3) can also be configured to receive and/or generate data in the form of computer-readable instructions from an external storage 520.

Examples of external storage 520 can include optical storage devices (e.g., CDs, DVDs etc.), hard drives, and flash storage devices (e.g., memory sticks or memory cards), among others. In some cases, semantic labeling component 516 and visualization component 518 can be installed on individual computing devices 502(1)-502(3) during assembly or at least prior to delivery to the consumer. In other scenarios, semantic labeling component 516 and visualization component 518 can be installed by the consumer, such as a download available over network 508 and/or from external storage 520. In various implementations, semantic labeling component 516 and visualization component 518 can be implemented as software, hardware, and/or firmware, or other manner.

The EMPI database 506 can include and/or reference patient files 522(1)-522(N). Each patient file can be associated with a unique identifier or patient identifier. In this example, patient file 522(1) is associated with unique identifier AB1, patient file 522(2) is associated with unique identifier AB2, and patient file 522(3) is associated with unique identifier AB3. Each patient file 522(1)-522(N) can include and/or reference structured data 524 and in some cases image data 526.

For purposes of explanation, assume that a patient is advised to be scanned by imaging device 504. In one implementation, the patient image data generated by the imaging device (termed “recent image data”) can be communicated to computing device 502(2). The recent image data can be associated with a unique patient identifier for tracking purposes. The computing device may store the recent image data as received and/or the computing device's semantic labeling component 516(2) and/or visualization component 518(2) may process the recent image data. Examples of semantic labeling techniques that can be employed by the semantic labeling component 516(2) are described below relative to FIG. 6.

Computing device 502(2) may transmit the recent image data, or links thereto, to EMPI database 506. For instance, in one scenario computing device 502(2) may semantically label the recent image data and send links and metadata to the EMPI database to be stored in the patient's file, but maintain the actual recent image data. In other implementations, the recent image data may be sent to the EMPI database.

In another instance, imaging device 504 and/or computing device 502(2) may send the recent image data to computing device 502(3) for processing. In this example, computing device 502(3) can represent a single computing device, multiple computing devices, and/or computing resources provided by unidentified computing devices (such as in a cloud scenario). Semantic labeling component 516(3) can perform semantic labeling on the recent image data. Semantic labeling component 516(3) can also perform semantic labeling on historic image data contained in the patient's file in the EMPI database.

Further, the visualization component 518(3) can process the semantically labeled recent image data and semantically labeled historic data to allow more valuable comparisons therebetween. The visualization component 518(3) can also obtain and process potentially relevant non-image data, such as lab results from the EMPI database. This processing preformed by computing device 502(3) can be performed in real-time or as resources become available. The results of this processing can be stored on computing device 502(3) and/or in EMPI database 506. The visualization component can cause individual semantically labeled anatomical structures from the recent image data to be displayed with non-image data that is relevant to the individual semantically labeled anatomical structures. Examples of such displaying are described above relative to FIGS. 2-3.

In one scenario, computing device 502(3) may, on a resource available basis, perform semantic labeling and registration on image data in the patient files of the EMPI database 506. The recent image data can be processed as received. For instance, a clinician associated with computing device 502(1) may request the patient be imaged on imaging device 504 and be awaiting the results. Computing device 502(3) could receive this request and check whether image data in the patient's file in the EMPI database has been semantically labeled. If not, the process can be completed while awaiting the recent image data. Once the recent image data is received, further semantic labeling and/or registration can be performed on computing device 502(3) to allow a GUI to be generated on computing device 502(1) that provides meaningful visualization of the patient's information for the clinician. Examples of such GUI visualization are described above relative to FIGS. 1-4. While a specific example is described here where a majority of the processing relating to the patient's image data is performed on computing device 502(3), other examples can perform such processing on any combination of computing devices 502(1)-502(3), either alone or in combination.

The visualization component 518 can also support customization by the user (e.g., clinician). The visualization component can then create a visualization library to allow instant reuse of data visualizations that are built or customized by users. In one implementation, the visualization library can be stored in EMPI database 506 to be accessible to various computing devices 502. In one case, the visualization library can create the equivalent of community submitted content that is localized to the customer's installation, such as a hospital or can be more broadly available.

Entries in the visualization library can contain not only the visualization, but also the metadata context of which data it applies to, and the filters that were in place at the time that the visualization was saved. This can allow true shortcutting of not just the visualization but also the filtered list of the text data to match.

Some system implementations can employ multi-tier processing with two, three, four or more tiers of processing, such as client, middle tier (rendering), back end (storage) and ingestion. The system can move semantic labeling and/or visualization algorithm(s) between these tiers (both client to server and server to client) so these algorithm(s) basically move to where the data is (or are activated where the data is). Also, the semantic labeling and/or visualization algorithm(s) can move across networks from one peer network to another.

### METHOD EXAMPLES

FIG. 6 illustrates a flowchart of an image data comparison technique or method 600.

For ease of explanation, method 600 is divided into automatic semantic labeling 602 and registration analysis 604.

Automatic semantic labeling 602 can be utilized to process recent image data and/or historical image data.

At block 606, the method can label image data. For instance, one or more semantic labeling techniques can be employed to accomplish the semantic labeling.

One semantic labeling technique can employ a random regression forest algorithm. A regression forest is a collection of regression trees which are trained to achieve direct mapping from voxels to organ location and size, in a single pass. In some cases, quantitative validation can be performed on a database of approximately 50 highly variable CT scans. The regression forest algorithm's simplicity of its context-rich visual features can yield typical runtimes of less than 10 seconds for a 512̂3 slice DICOM CT series on a single-threaded, single-core Windows® machine running on multiple trees; each tree taking less than a second. Of course, this is only one example and processing speeds tend to improve with advances in system components.

This random regression forest algorithm can estimate a position of a bounding box around an anatomical structure by pooling contributions from all voxels in volume of image data. This approach can cluster voxels together based on their appearance, their spatial context and/or, their confidence in predicting position and size of all anatomical structures.

The regression trees can act as the basis of the forest predictor and can be trained on a predefined set of volumes with associated ground-truth bounding boxes. The training process can select at each node the visual feature that maximizes the confidence on its prediction for a given structure. The tighter the predicted bounding box distribution, the more likely that feature is selected in a node of the tree.

During the testing phase, voxels in an image volume are provided as an input to all the trees in the forest, simultaneously. At each node the corresponding visual test is applied to the voxel and based on the outcome the voxel is sent to the left or right child. When the voxel reaches a leaf node, the stored distribution is used as the probabilistic vote cast by the voxel itself. In some cases, only the leaves with highest localization confidence are used for the final estimation of each organ's bounding box location. Further details regarding this semantic labeling technique can be found in a U.S. patent application, having Ser. No. 12/697,785, filed on Feb. 1, 2010, and assigned to the same entity as the present application. application Ser. No. 12/697,785 is hereby incorporated by reference in its entirety. Of course, the present implementations can employ other semantic labeling techniques. Please note that one type of semantic labeling algorithm is described above that relates to random forests. The present concepts can employ other types of semantic labeling algorithms.

Returning to FIG. 6, in some cases, at 608 a context of the image data can be utilized in an iterative manner to accomplish further semantic labeling of sub-structures in the image data. For instance, the adrenal glands may be difficult to correctly locate from a large amount of image data. However, once a sub-set of the image data is semantically labeled as being associated with the kidney, this sub-set of the data may be reprocessed with the semantic labeling algorithm to correctly label the adrenal glands. The context may come from beyond the image data. For instance, assume that the liver was initially semantically labeled. Further assume that structured data in the patient's file indicates that the patient's gallbladder was removed. In such a case, this information can be utilized to avoid improperly labeling a structure in the image as the gallbladder.

Labeled image data 610 is made available for further processing. In this case, current or recent image data 612 is handled differently from historical image data 614. At 616, a transform is calculated from the current labeled image data 612 and the historical labeled image data 614. At 618, the calculated transform is performed on the historical image data 614 to produce transformed labeled image data 620. The transform can enhance the consistency between the historical labeled image data 614 and the current image data 612. For instance, the historical image data 614 may be manipulated so that a size and/or orientation of a labeled anatomical structure in the image data matches (or approaches) the image size and/or orientation of the structure in the current image data.

In some scenarios performing the transformation can include synthesizing a view from the historical labeled image data 614 to match a corresponding view in the current labeled image data 612. For instance, assume that the current data includes an axial view of the liver and the historical data does not. Block 620 can allow the synthesis of a corresponding axial view from available historical image data, such as from coronal and sagittal view data.

The transformed labeled image data 620 can be compared to the current labeled image data at 622. The transformation can allow more meaningful comparison of the patient's present condition with the patient's historical condition.

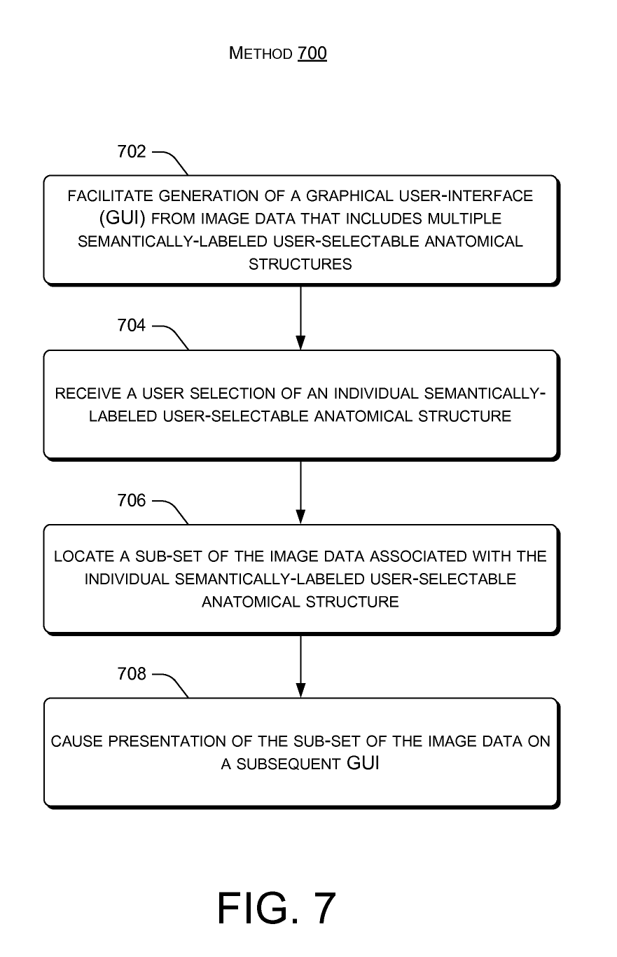

FIG. 7 illustrates a flowchart of another image data comparison technique or method 700.

At block 702, the method can facilitate generation of a graphical user-interface (GUI) from image data that includes multiple semantically-labeled user-selectable anatomical structures.

At block 704, the method can receive a user selection of an individual semantically-labeled user-selectable anatomical structure.

At block 706, the method can locate a sub-set of the image data associated with the individual semantically-labeled user-selectable anatomical structure.

At block 708, the method can cause presentation of the sub-set of the image data on a subsequent GUI.

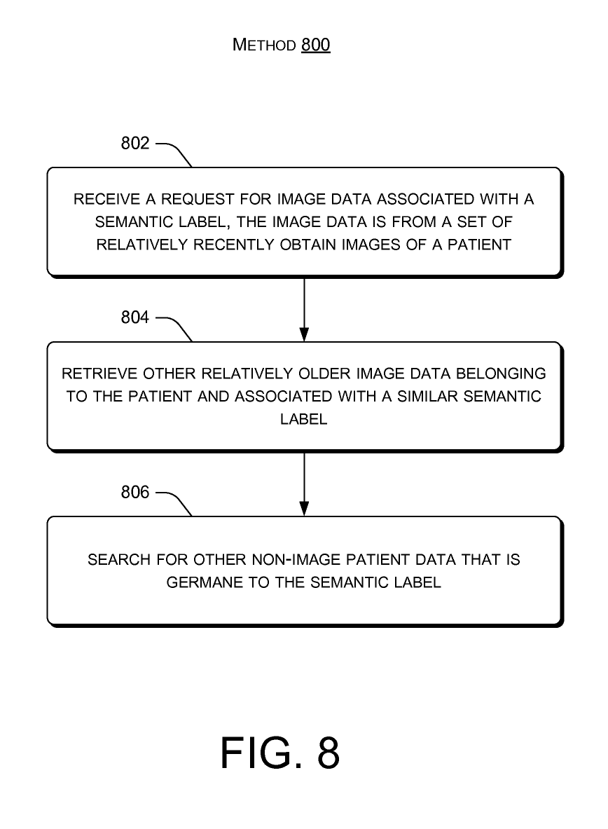

FIG. 8 illustrates a flowchart of another image data comparison technique or method 800.

At block 802, the method can receive a request for image data associated with a semantic label. The image data can be from a set of relatively recently obtain images of a patient.

At block 804, the method can retrieve other relatively older image data belonging to the patient and associated with a similar semantic label.

At block 806, the method can search for other non-image patient data that is germane to the semantic label.

The order in which the example methods are described is not intended to be construed as a limitation, and any number of the described blocks or steps can be combined in any order to implement the methods, or alternate methods. Furthermore, the methods can be implemented in any suitable hardware, software, firmware, or combination thereof, such that a computing device can implement the method. In one case, the method is stored on one or more computer-readable storage media as a set of instructions such that execution by a computing device causes the computing device to perform the method.

### CONCLUSION

Although techniques, methods, devices, systems, etc., pertaining to automatically labeling and presenting image data are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. At least one computer-readable storage medium having instructions stored thereon that, when executed by a computing device, cause the computing device to perform acts, comprising:
facilitating a graphical user-interface (GUI) to be generated from image data that includes multiple semantically-labeled user-selectable anatomical structures;
receiving a user selection of an individual semantically-labeled user-selectable anatomical structure;
locating a sub-set of the image data associated with the individual semantically-labeled user-selectable anatomical structure; and,
causing presentation of the sub-set of the image data on a subsequent GUI.

2. The computer-readable storage medium of claim 1, wherein the facilitating further comprises allowing the user to select one or more views for the presentation.

3. The computer-readable storage medium of claim 2, wherein the facilitating further comprises allowing the user to select non-image patient data to be displayed on the presentation.

4. The computer-readable storage medium of claim 1, wherein the receiving is responsive to a user clicking on the individual semantically-labeled user-selectable anatomical structure or responsive to the user entering text corresponding to the individual semantically-labeled user-selectable anatomical structure in a command window.

5. The computer-readable storage medium of claim 1, wherein the image data comprises recent image data from a patient and further comprising obtaining historical image data of the patient and transforming the historical image data in a manner that promotes a meaningful comparison between the recent image data and the historical image data.

6. The computer-readable storage medium of claim 5, further comprising aligning the transformed historical image data with the recent image data.

7. The computer-readable storage medium of claim 1, further comprising selecting a view for the sub-set of image data and in an instance where historical image data of the individual semantically-labeled anatomical structure is located, but the located historical image data does not match the view, synthesizing a view of the historical image data from the available historical image data.

8. The computer-readable storage medium of claim 1, wherein the locating further comprises searching for corresponding historical image data that includes a matching semantically-labeled anatomical structure.

9. The computer-readable storage medium of claim 1, further comprising automatically adjusting a parameter of the anatomical structure in the presentation to distinguish the anatomical structure from surrounding tissues.

10. The computer-readable storage medium of claim 1, further comprising processing the sub-set of image data utilizing a context-based semantic labeling algorithm to identify elements of the anatomical structure.

11. The computer-readable storage medium of claim 1, wherein the sub-set of image data includes a first semantically-labeled image and further comprising leveraging the first semantically-labeled image to automatically semantically label anatomical structures in a second image.

12. The computer-readable storage medium of claim 1, wherein the locating comprises automatically processing the image data utilizing a semantic labeling algorithm.

13. The computer-readable storage medium of claim 1, further comprising identifying non-image patient data that is relevant to the user-selected anatomical structure.

14. At least one computer-readable storage medium having instructions stored thereon that, when executed by a computing device, cause the computing device to perform acts, comprising:
receiving a request for image data associated with a semantic label, wherein the image data is from a set of relatively recently obtained images of a patient;
retrieving other relatively older image data belonging to the patient and associated with a similar semantic label; and,
searching for other non-image patient data that is germane to the semantic label.

15. The computer-readable storage medium of claim 14, wherein the retrieving further comprises causing the relatively older image data to be semantically labeled.

16. The computer-readable storage medium of claim 14, wherein the retrieving further comprises transforming the relatively older image data to match a size or view of the relatively recently obtained images.

17. The computer-readable storage medium of claim 16, wherein the transforming is accomplished via a registration process.

18. A system, comprising:
a semantic labeling component configured to cause recent image data to be semantically labeled; and,
a visualization component configured to cause individual semantically labeled anatomical structures from the recent image data to be displayed with non-image data that is relevant to the individual semantically labeled anatomical structures.

19. The system of claim 18, wherein the visualization component is further configured to register semantically labeled historic image data and to cause a presentation to be generated that includes both the semantically labeled recent image data and the registered semantically labeled historic image data.

20. The system of claim 18, wherein the visualization component is further configured to perform a quality control evaluation based upon the individual semantically labeled anatomical structures and the non-image data.
